(19) United States
(12) Patent Application Publication
(10) Pub. No.: US 2026/0108874 A1
(43) Pub. Date: Apr. 23, 2026

(54) Biodegradable Test Kit

(71) Applicant: DANIMER IPCO, LLC, Bainbridge, GA (US)

(72) Inventors: Carol G. LEGGETT, Whigham, GA (US); Cheryl G WARE, Whigham, GA (US); Phillip VAN TRUMP, Whigham, GA (US)

(21) Appl. No.: 19/153,127

(22) PCT Filed: Feb. 1, 2024
(86) PCT No.: PCT/US2024/013954

§ 371 Date: Aug. 1, 2025

Related U.S. Application Data
(60) Provisional application No. 63/483,027, filed on Feb. 3, 2023.

(51) Int. Cl. B01L 3/00

(52) U.S. Cl. CPC B01L 3/5023; B01L 2200/12; B01L 2300/0825; B01L 2300/12

(57) ABSTRACT

A biodegradable test kit and a method for making a biodegradable test kit. The biodegradable test kit includes a first molded body section and a second molded body section configured to be attached to the first molded body section for holding a test strip between the first molded body section and second molded body section, wherein the first and second molded body sections comprise from about 50 to about 99.5 weight percent poly hydroxyalkanoate.

### RELATED APPLICATION

The present application is a United States National Stage of International Application No. PCT/US2024/013954 filed on Feb. 1, 2024, published as WO 2024/163714, and claims the benefit of U.S. Provisional Application 63/483,027 filed on Feb. 3, 2023. The entire contents of these applications are incorporated herein by reference in their entirety.

### TECHNICAL FIELD

The disclosure relates biodegradable test kits and in particular to biodegradable cartridges for biological and chemical test kits.

### BACKGROUND AND SUMMARY

Test kits that are often used for chemical and biological testing of water and food products, as well as testing for monoclonal or polyclonally labeled antibodies, such as in pregnancy tests, drug tests, viral tests, and the like. The test kits may be used to determine if toxic or hazardous chemicals are present in food, water samples, air, blood, or on environmental surfaces, and the like. The test kits typically include an absorbent test strip that is retained in a cartridge body structure. The test kit includes an inlet for applying a chemical reagent to be absorbed by the test strip. Because a wide variety of chemicals may be used with the test kits, the tests kits are typically made of plastic or other resilient material. However, conventional test kits are typically non-biodegradable. Accordingly the test kits do not degrade over time and thus cannot be buried at the point of use once the test is complete. Accordingly, what is needed is a test kit that is made of biodegradable materials so that the test kit can be disposed of at the use location and will degrade rapidly over time.

In view of the foregoing, there is provided a biodegradable test kit comprising a first molded body section and a second molded body section configured to be attached to the first molded body section for holding a test strip between the first molded body section and second molded body section, wherein the first and second molded body sections comprise from about 50 to about 99.5 weight percent polyhydroxyalkanoate.

In some embodiments, the polyhydroxyalkanoate is selected from the group consisting of homopolymer, a copolymer, a terpolymer, and mixtures thereof of a hydroxyalkanoate. In other embodiments, the polyhydroxyalkanoate comprises poly-3-hydroxybutyrate-co-3-hydroxyhexanoate. In some embodiments, the polyhydroxyalkanoate comprises a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

In some embodiments, the first and second molded body sections are composed of a material that comprises a major amount of polyhydroxyalkanoate and a minor amount of one or more additional biodegradable polymers selected from the group consisting of polycaprolactone, polylactic acid, polybutylene succinate, polybutylene succinate-co-butylene adipate, polybutylene adipate terephthalate, other biodegradable polymers, and mixtures thereof.

In some embodiments, the first and second molded body sections are biodegradable as determined by ASTM D5988.

In another embodiment, there is provided a method for making a biodegradable test kit. The method includes molding first and second body sections of the biodegradable test kit from about 50 to about 99.5 weight percent polyhydroxyalkanoate. A test indicator strip is attached to one of the first and second body sections and the first and second body sections are attached to one another so that the test strip is between the first and second body sections.

A particular advantage of the disclosed embodiments is the test kit may be disposed of by burying the test kit in the ground after use so that it decomposes over time. Accordingly, there is no need to collect used the biodegradable test kits and transport the used test kits to a disposal area. Other benefits and advantages of the disclosed embodiments may be evident by reference to the drawings and detailed description thereof.

### BRIEF DESCRIPTION OF THE DRAWINGS

FIG. 1 is an exploded view of a biodegradable test kit showing a first molded body section and second molded body section made from a biodegradable polymer and a test trip for use with the biodegradable test kit.

FIG. 2 is an illustration for the test kit of claim 1 with the test strip placed in a second molded body section of the test kit.

FIG. 3 is a plan view of another test kit having body sections made from a biodegradable polymer according to the disclosure.

FIG. 4 is a plan view of another test kit having body sections made from a biodegradable polymer according to the disclosure.

FIG. 5 is a top perspective view of a micro-well plate made from a biodegradable polymer according to the disclosure.

### DETAILED DESCRIPTION OF EMBODIMENTS

The disclosure answers the need for test kits that are disposable and have increased biodegradability and/or compostability.

As used herein, “ASTM” means American Society for Testing and Materials.

As used herein, “alkyl” means a saturated carbon-containing chain which may be straight or branched; and substituted (mono- or poly-) or unsubstituted.

As used herein, “alkenyl” means a carbon-containing chain which may be monounsaturated (i.e., one double bond in the chain) or polyunsaturated (i.e., two or more double bonds in the chain); straight or branched; and substituted (mono- or poly-) or unsubstituted.

As used herein, “PHA” means a poly(hydroxyalkanoate) as described herein having random monomeric repeating units of the formula:

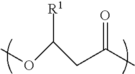

wherein R1 is selected from the group consisting of CH₃ and a C₃ to C₁₉ alkyl group. The monomeric units wherein R¹ is CH₃ is about 75 to about 99 mol percent of the polymer.

As used herein, “P₃HB” means the poly-(3-hydroxybutyrate).

As used herein, “P₃HHx” means the poly(3-hydroxyhexanoate).

As used herein, “biodegradable” means the ability of a compound to ultimately be degraded completely into CO₂ and water or biomass by microorganisms and/or natural environmental factors, according to ASTM D5511 (anaerobic and aerobic environments), ASTM 5988 (soil environments), ASTM D5271 (freshwater environments), or ASTM D6691 (marine environments). Biodegradability can also be determined using ASTM D6868 and European EN 13432.

As used herein, “compostable” means a material that meets the following three requirements: (1) the material is capable of being processed in a composting facility for solid waste; (2) if so processed, the material will end up in the final compost; and (3) if the compost is used in the soil, the material will ultimately biodegrade in the soil according to ASTM D6400 for industrial and home compostability.

All copolymer composition ratios recited herein refer to mole ratios, unless specifically indicated otherwise.

Unless otherwise noted, all molecular weights referenced herein are weight average molecular weights, as determined in accordance with ASTM D5296.

According to embodiments of the disclosure, test kits are provided that have molded body sections made of a biodegradable polymer. In some embodiments, the test kits include an absorbent test strip that is secured in the molded body sections and is used with various reagents to provide a colorimetric test result. For example, a rapid antigen test uses a collected sample that is developed against the lipopolysaccharide (LPS, specifically the Lipid A component) that is present in the cell wall of Gram-negative bacteria. Accordingly, the rapid antigen test may include a dipstick, similar to a pregnancy test for HCG or may include a well for placing the sample therein, after which reagents are added to the well. In other embodiments, the test kit includes a solid molded surfaces to which antibodies or immune-markers, proteins or fluorescent markers may be absorbed, or incorporated.

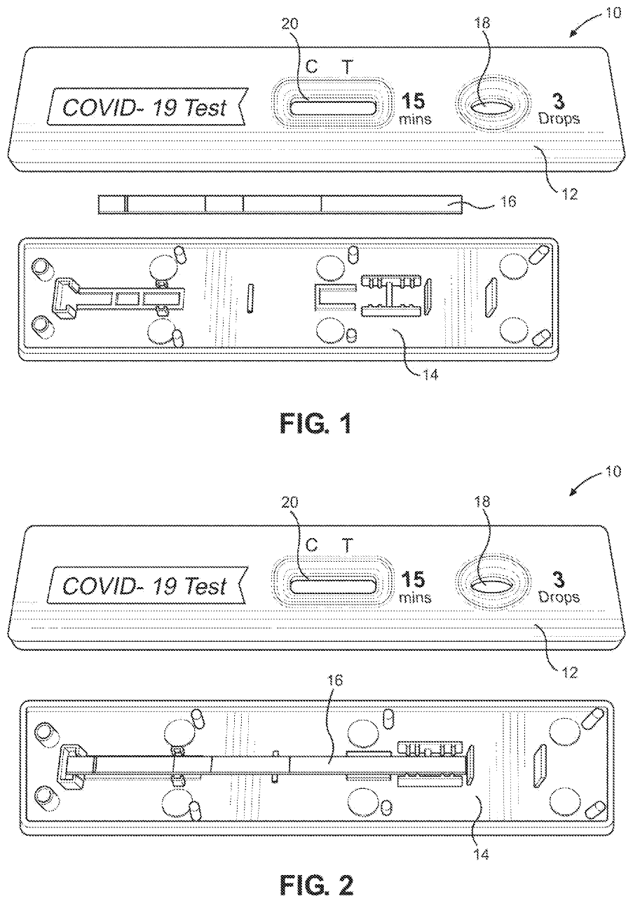

FIGS. 1-2 illustrate a rapid test device 10 that may be used for a variety of applications, such as a rapid Covid test, and includes a first molded body section 12, a second molded body section 14, and an absorbent test strip 16 made of a nitrocellosic material that is encased between the first body section 12 and second body section 14. A test sample is applied to sample well 18 so that it is absorbed by the test strip 16 and provides a positive or negative indication in window 20 of the first body section. The immunochromatographic lateral flow assay would use a highly sensitive antibody to detect antigen present in the sample being tested. Specific antibodies and a control antibody are immobilized onto the test strip 16 as two distinct lines. The test line (T) region would contain monoclonal anti-Lipid A antibodies, and the control line (C) region would contain polyclonal control antibodies. Polyclonal and monoclonal anti-Lipid A antibodies conjugated with red-colored colloidal gold particles are used to detect the Lipid A antigen. If testing a solid sample, the sample would be mixed in a buffer solution, then the buffer solution would be applied to the sample well 18 of the test device 10. If the Lipid A antigen is present, it will bind to the antibody-gold conjugate forming an immunocomplex. The immunocomplex will then travel across the test strip 16 via capillary action towards the test line. The immunocomplex will then bind to the anti-Lipid A antibodies at the test line (T), forming a visible red-colored line to indicate detection of antigens. If Lipid A antigens are not detected in the sample, no color will appear at the test line (T). If the sample to be tested is a liquid, no buffer solution is used and the sample is dropped directly onto the sample well 18. The control (C) line is used for procedural control and should appear regardless of the test result. The appearance of the control line (C) serves to ensure the test is performing properly and the test result is valid. According to an embodiment of the disclosure, the first and second molded body sections 12 and 14 are made of a biodegradable polymer as described in more detail below resulting in a device that could be buried onsite and has an estimated degradation time of 90-120 days. In some embodiments, the test kit is made of a biodegradable polymer as described herein and may be recycled rather than biodegraded.

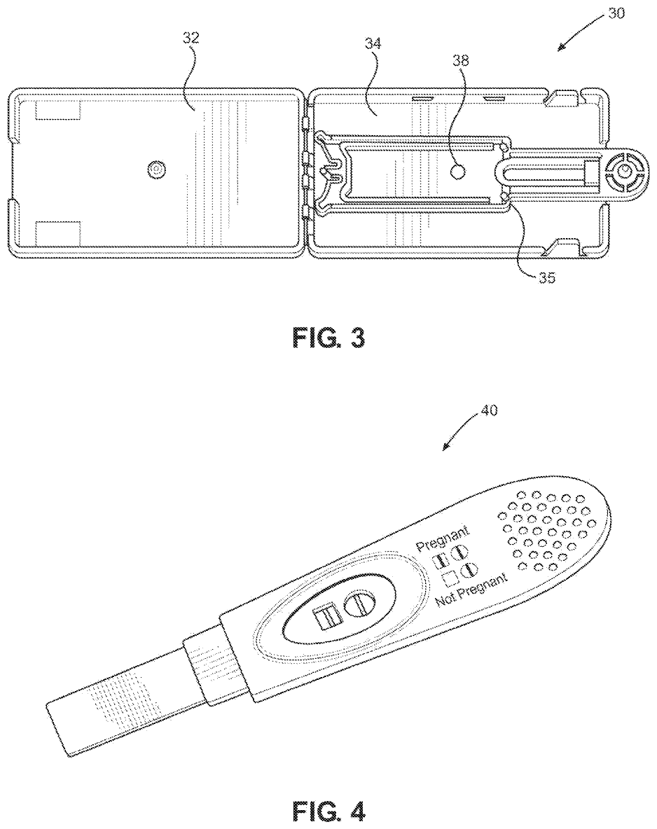

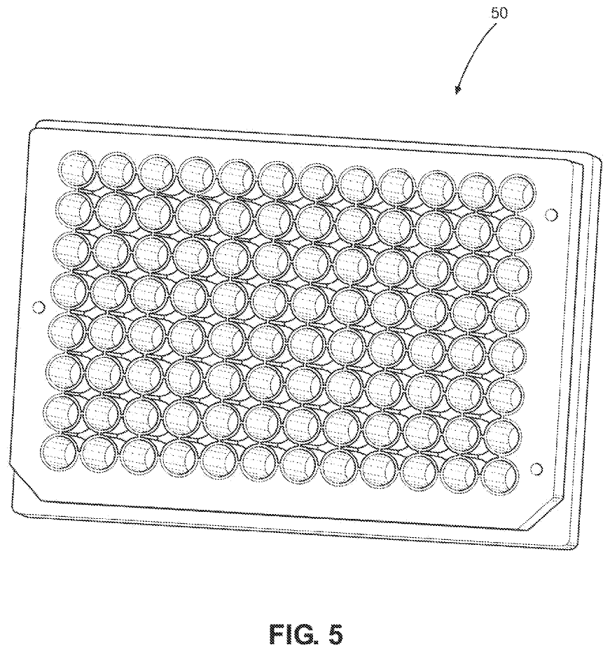

FIGS. 3 and 4 illustrate other test kits having body sections that are made of biodegradable polymers. In FIG. 3, the test kit 30 includes a first molded body section 32 that is higedly connected to a second molded body section 34. A test strip retainer 36 is provided in the second molded body section 36 to retain an absorbent test strip. A sample hole 38 is provided in the second molded body section 34 for applying a sample to be tested to the test strip. FIG. 4 illustrates a pregnancy test kit 40 that has molded body sections made from a biodegradable polymer as described herein. Other embodiments that may use the biodegradable polymers described herein may include micro-well plates 50 (FIG. 5) having 96 or 394 micro-wells therein or any other solid molded device surface to which antibodies or immune-markers, proteins or fluorescent markers may be absorbed, or incorporated.

For all of the test kits described herein, the biodegradable polymers used are polymers that are resistant to the chemicals and solvents used with the test kits. In one embodiment of the disclosure, at least about 50 mol %, but less than 100 mol %, of the monomeric repeating units of the biodegradable polymer have CH₃ as R¹, more preferably at least about 60 mol %; more preferably at least about 70 mol %; more preferably at least about 75 to 98 mol %.

In another embodiment, a minor portion of the monomeric repeating units have R¹ selected from alkyl groups containing from 3 to 19 carbon atoms. Accordingly, the polymer may contain from about 0 to about 30 mol %, preferably from about 1 to about 25 mol %, and more particularly from about 2 to about 10 mol % of monomeric repeating units containing a C₃ to C₁₉ alkyl group as R¹.

According to certain embodiments, the molded body sections described above are preferably made up of at least 50 weight percent polyhydroxyalkanoates (PHA). In some embodiments, the PHA polymer is a copolymer that includes from about 94 mole % to about 98 mole percent repeat units of 3-hydroxybutyrate and from about 2 to about 6 mole percent repeat units of 3-hydroxyhexanoate.

Different forms of polyhydroxyalkanoates may be used to make the molded body sections of the biodegradable test kits described above. In general, the polyhydroxyalkanoates of the substrate may be either a homopolymer, a copolymer, or a terpolymer. In some embodiments, the polyhydroxyalkanoates preferably includes poly-3-hydroxybutyrate-co-3-hydroxyhexanoate (“P(3HB-co-3HHₓ)”). In other embodiments, the polyhydroxyalkanoates preferably includes a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

In some embodiments, the molded body sections of the biodegradable test kit may also include at least one addition one biodegradable polymer selected from the group consisting of polycaprolactone, polylactic acid, polybutylene succinate, polybutylene succinate-co-butylene adipate, polybutylene adipate terephthalate, and mixtures thereof.

### Synthesis of Biodegradable PHAs

Biological synthesis of the biodegradable PHAs described herein may be carried out by fermentation with the proper organism (natural or genetically engineered) with the proper feedstock (single or multicomponent). Biological synthesis may also be carried out with bacterial species genetically engineered to express the copolymers of interest (see U.S. Pat. No. 5,650,555, incorporated herein by reference.

### Melt Temperature

Preferably, the biodegradable PHAs of the disclosure have a melt temperature (Tₘ) of from about 30° C. to about 170° C., more preferably from about 90° C. to about 165° C., more preferably still from about 130° C. to about 160° C.

### Molded Body Sections

According to the disclosure, a biodegradable test kit is formed from a resin comprising a polymer or copolymer materials (e.g., PHA) which are injection molded into the desired shape. Injection molding of thermoplastics is a multi-step process by which a PHA formulation of is heated until it is molten, then forced into a closed mold where it is shaped, and finally solid-ified by cooling. The body sections of the test kits described above may be made by modifying PHA with melt strength enhancers, chain extenders, and other processing aids. During the injection molding process, the PHA formulation may be heated to a temperature ranging from about 135° C. to about 205° C. Care should be taken to prevent overheating the PHA formulation during the molding process to prevent thermal degradation of the polymer.

The PHAs according to the disclosure may contain from about 40 to 99 weight percent of poly(hydroxyalkanoate) copolymer and from about 1 to about 60 wt. % polymer modifiers. In some embodiments, the poly(hydroxyalkanoate) copolymer is poly-3-hydroxybutyrate-co-3-hydroxyhexanoate (P₃HB-co-P₃HHₓ). In other embodiments, the PHA composition includes from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

In some embodiments, the PHA formulation used to make biodegradable test kits may include from about 0.5 weight percent to about 15 weight percent of at least one plasticizer selected from the group consisting of sebacates, citrates, fatty esters of adipic, succinic, and glucaric acids, lactates, alkyl diesters, citrates, alkyl methyl esters, dibenzoates, propylene carbonate, caprolactone diols having a number average molecular weight from 200-10,000 g/mol, polyethylene glycols having a number average molecular weight of 400-10,000 g/mol, esters of vegetable oils, long chain alkyl acids, adipates, glycerol, isosorbide derivatives or mixtures thereof.

In other embodiments, the PHA formulation may include from about 0.1 weight percent to about 10 weight percent, or from about 0.1 to about 20 weight percent, of at least one nucleating agent selected from sulfur, erythritols, pentaerythritol, dipentaerythritols, inositols, stearates, sorbitols, mannitols, polyester waxes, compounds having a 2:1; 2:1 crystal structure chemicals, boron nitride, and mixtures thereof.

In certain preferred embodiments, the PHA formulation may include from about 0.1 to about 3 weight percent of a nucleating agent selected from boron nitride or pentaerythritol, and more preferably from about 0.3 to about 1.5 weight percent of boron nitride or pentaerythritol. Moreover, in instances in which boron nitride is used as a nucleating agent, the PHA formulation may also include from about 1 to about 5 weight percent of poly(hydroxybutyrate) homopolymer in addition to poly(hydroxyalkanoate) copolymer.

In some embodiments, the PHA formulation preferably includes from about 0 to about 1 percent by weight, such as from about 1 to about 0.5 percent by weight of a melt strength enhancer/rheology modifier. The melt strength enhancer may for instance be selected from the group consisting of a multifunctional epoxide; an epoxy-functional, styrene-acrylic polymer; an organic peroxide such as di-t-butyl peroxide; an oxazoline; a carbodiimide; and mixtures thereof.

Without being bound by theory, this additive is believed to act as a cross-linking agent to increase the melt strength of the PHA formulation. Alternatively, in some instances, the amount of the melt strength enhancer is from about 0.05 to about 3 weight percent. More preferred melt strength enhancers include organic peroxides, epoxides, and carbodiimides, preferably in an amount from about 0.05 to about 0.2 weight percent of the PHA formulation. In some embodiments, the PHA formulation includes unsaturated monomeric units in the polymer to enable cross-linking of the polymer without the use of melt strength enhancer/rheology modifier compounds.

In some embodiments, the PHA formulation may include one or more performance enhancing polymers selected from poly(lactic acid), poly(caprolactone), poly(ethylene sebicate), poly(butylene succinate), and poly(butylene succinate-co-adipate), and copolymers and blends thereof. The performance enhancing polymers may be present in the formulation in a range of from about 1 to about 60 percent by weight. In some embodiments, from about 0.1 to about 15 weight percent of polylactic acid fibers are included in the polymer formulation for structural support of containers made from the polymer formulation.

In some embodiments, the polymer formulation includes from about 0.1 to about 5 weight percent of a reheat agent such as carbon black or another infrared absorbing material. In other embodiments, the polymer includes from about 0.1 to about 20 weight percent (preferably from about 0.1 to about 10 weight percent) of a filler selected from calcium carbonate, talc, starch, zinc oxide, neutral alumina, and mixtures thereof.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A biodegradable test kit comprising a first molded body section and a second molded body section configured to be attached to the first molded body section for holding a test strip between the first molded body section and second molded body section, wherein the first and the second molded body section are composed of a material that comprises between 50 weight percent to 99.5 weight percent polyhydroxyalkanoate.

2. The biodegradable test kit of claim 1, wherein the polyhydroxyalkanoate is selected from the group consisting of homopolymer, a copolymer, a terpolymer, and mixtures thereof of a hydroxyalkanoate.

3. The biodegradable test kit of claim 1, wherein the polyhydroxyalkanoate comprises poly-3-hydroxybutyrate-co-3-hydroxyhexanoate.

4. The biodegradable test kit of claim 1, wherein the polyhydroxyalkanoate comprises a terpolymer made up from about 75 mole percent to about 99.9 mole percent monomer residues of 3-hydroxybutyrate, from about 0.1 mole percent to about 25 mole percent monomer residues of 3-hydroxyhexanoate, and from about 0.1 mole percent to about 25 mole percent monomer residues of a 3-hydoxyalkanoate having from 5 to 12 carbon atoms, where the first molded body section and the second molded body section are biodegradable as determined by ASTM D5988.

5. The biodegradable test kit of claim 1, where the first molded body section and the second molded body section are composed of a material that comprises a major amount of the polyhydroxyalkanoate and a minor amount of one or more additional biodegradable polymers selected from the group consisting of polycaprolactone, polylactic acid, polybutylene succinate, polybutylene succinate-co-butylene adipate, polybutylene adipate terephthalate, other biodegradable polymers, and mixtures thereof.

6. (canceled)

7. A method for making a biodegradable test kit comprising molding first and second body sections of the biodegradable test kit from about 50 to about 99.5 weight percent polyhydroxyalkanoate;
attaching a test indicator strip to one of the first body section and the second body sections, and
attaching the first and second body sections to one another so that the test strip is between the first body section and the second body section.

8. The method of claim 7, wherein the polyhydroxyalkanoate is selected from the group consisting of homopolymer, a copolymer, a terpolymer, and mixtures thereof of a hydroxyalkanoate.

9. The method of claim 7, wherein the polyhydroxyalkanoate comprises poly-3-hydroxybutyrate-co-3-hydroxyhexanoate.

10. The method of claim 7, wherein the polyhydroxyalkanoate comprises a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

11. The method of claim 7, where the first and second body sections comprise a major amount of polyhydroxyalkanoate and a minor amount of one or more additional biodegradable polymers selected from the group consisting of polycaprolactone, polylactic acid, polybutylene succinate, polybutylene succinate-co-butylene adipate, polybutylene adipate terephthalate, and mixtures thereof.

12. (canceled)

13. (canceled)

14. (canceled)

15. (canceled)
